(19) United States
(12) Patent Application Publication
(10) Pub. No.: US 2009/0095141 A1
(43) Pub. Date: Apr. 16, 2009

(54) ADJUSTABLE FENCE FOR A MITER SAW

(75) Inventors: Ross A. Billings, Jackson, TN (US); Daryl S. Meredith, York, PA (US)

Correspondence Address: Doherty IP Law Group LLC, 37 Belvidere Ave, Washington, NJ, 07882, US

(73) Assignee: Black & Decker Inc., Towson, MD (US)

(21) Appl. No.: 11/872,674

(22) Filed: Oct. 15, 2007

(51) Int. Cl. B23D 45/04

(52) U.S. Cl. 83/468.3

(57) ABSTRACT

A miter saw includes a base, a table rotatably coupled with the base, and a cutting assembly connected to the table. The miter saw includes a fence assembly attached to the base and overlying the top surface of the table. The fence assembly has a fixed fence with a front face, a rear face, a top surface extending between the front and rear faces, and an elongated tongue projecting from the top surface. The fence assembly also has a movable fence with a front face, a rear face and an elongated groove formed in an underside thereof adapted to engage the elongated tongue for guiding movement of the movable fence over the fixed fence. The fence assembly includes at least one spring projecting from the elongated tongue for urging the movable fence toward the rear face of the fixed fence and into enhanced surface contact with the fixed fence.

### BACKGROUND OF THE INVENTION

1. Field of the Invention

The present invention generally relates to equipment used for cutting workpieces, and more specifically relates to miter saws and power operated equipment having workpiece-supporting fences.

2. Description of the Related Art

During construction, manufacturing, and assembly operations, pieces of material such as wood, plastic, and metal (i.e. workpieces) must be cut to exact lengths, shapes, and dimensions. In many instances, power equipment and saws are used for cutting these workpieces. One type of saw, commonly referred to as a miter saw, has a cutting blade, a motor for driving the cutting blade, a horizontally-extending table, and a vertically-extending fence that cooperates with the table to support the workpieces during cutting operations. The horizontally-extending table provides a horizontal support surface for the workpieces, and the fence that provides a vertical support surface for the workpieces. In many designs, the workpiece-supporting fence is divided into two parts that are separated from one another. A gap, which is adapted to accommodate the cutting blade, extends between the two fence parts. Each fence part has a vertically-extending support surface. The two support surfaces are designed to lie in a common plane.

The cutting blade of a miter saw is selectively rotatable about a vertically-extending axis for making vertical cuts at various angles relative to the vertical support surface of the fence. These vertical cuts are typically referred to as miter cuts.

In addition to conventional miter saws used to make vertical cuts, there are other types of miter saws that are used to make even more complex cuts. For example, a compound miter saw has a cutting blade that may be tilted at an angle relative to the horizontally-extending table, generally from 0 degrees to 45 degrees left of vertical. A cut made with the blade tilted at an angle to the table, while remaining perpendicular to the fence, is known as a “bevel cut” A cut made with the blade set at an angle relative to the fence (miter angle) and an angle relative to the base (bevel angle) is known as a “compound cut.”

Another type of miter saw is commonly referred to as a dual bevel compound miter saw, which has a tiltable structure that enables the cutting blade to be positioned at a range of angles relative to the table from 45 degrees left of vertical to 45 degrees right of vertical. This arrangement allows for even more “compound cut” variations. Still another type of miter saw is a slide miter saw including a rail system that enables the saw component to slide backward and forward so as to increase the saw's cutting capabilities. In many instances, a single miter saw may include all of the above-described features.

In order to accommodate the many different cutting operations outlined above, the workpiece-supporting fence is at least partially adjustable in order to selectively vary the gap between a first section of the fence and a second section of the fence. If the fence did not have an adjustable section, it would be necessary to provide a relatively large permanent gap between sections of the fence in order to accommodate the various angles, movements, positions, and sizes of the cutting blade. Thus, in order to provide adequate workpiece support when performing operations that do not require such large clearance, the above mentioned adjustable fence assemblies, having at least one movable fence, have frequently been provided.

In spite of the above advances, there are many problems associated with fences used with miter saws and power equipment. These problems include difficulty in maintaining proper alignment when a wide gap is present between a first section of a fence and a movable section of the fence, inconvenience in performing fence adjustment operations, the possibility of inadvertently misplacing a movable fence, and/or a lack of adequate support for relatively tall or thick workpieces.

In addition, there have been many problems related to properly securing a moving fence section to a fixed fence, and correctly aligning the vertical support surface of a fixed fence with the vertical support surface of the moving fence section associated therewith. In many instances, instability remains between the fixed fence and the moving fence section, even after the parts have been locked together. It has also been observed that the elements used to lock the fixed and moving fence parts together actually cause the vertical workpiece supporting faces to become misaligned.

Thus, there remains a need for improved fences for miter saws and power equipment that are economical, safe, reliable, and easy to use. There also remains a need for fences that provide uniform and stable planar faces for supporting workpieces.

### SUMMARY OF THE INVENTION

Embodiments of the present invention relate to fences used for supporting workpieces during cutting and shaping operations.

In one embodiment of the present invention, a saw includes a base, and a saw assembly coupled with the base, the saw assembly including a cutting blade, a motor for driving the cutting blade, and a linkage for selectively moving the saw assembly relative to the base. The saw includes a fence assembly attached to the base, the fence assembly including a fixed fence having a front face, and a rear face, and a movable fence having a front face and a rear face, which is movably connected to the fixed fence. The fence desirably includes at least one spring disposed between the fixed fence and the movable fence for urging the movable fence into engagement with the fixed fence.

In one embodiment, the fixed fence preferably has a top surface extending between the front face and the rear face thereof, and an elongated tongue projecting from the top surface that extends between first and second ends of the fixed fence. The movable fence may have a top surface, a bottom surface, and an elongated groove formed in the bottom surface that extends between first and second ends of the movable fence, the elongated groove and the elongated tongue being engageable with one another for guiding movement of the movable fence relative to the fixed fence.

The elongated tongue may include a leading face that is substantially parallel with the front face of the fixed fence, a trailing face that is substantially parallel with the leading face of the elongated tongue, and a top surface extending between the leading and trailing faces of the tongue, the top surface of the elongated tongue being substantially perpendicular to the front face of the fixed fence. In one embodiment, the leading and trailing faces of the tongue may have different heights and the top surface of the tongue may be inclined between the leading and trailing faces of the tongue. In one embodiment of the present invention, the at least one spring projects from the trailing face of the elongated tongue for engaging the movable fence. Moreover, the at least one spring desirably urges the front face of the movable fence into substantial coplanar alignment with the front face of the fixed fence. In one embodiment of the present invention, the at least one spring may include two or more springs projecting from the trailing face of the elongated tongue. The two or more springs are preferably spaced from one another. The front faces of the movable and fixed fences desirably cooperate to form a fence plane for supporting a workpiece. The fence plane desirably extends in a vertical direction and is preferably substantially perpendicular to the top surface of a base or the top surface of a table attached to the base.

In one embodiment of the present invention, the elongated tongue of the fixed fence preferably has a bore accessible at a top surface thereof, and the movable fence has an elongated slot extending from the top surface thereof to the elongated groove thereof. The fence assembly may include a fastener, such as a locking element or locking screw, extendable through the elongated slot of the movable fence and into the bore of the fixed fence for selectively locking the movable fence to the fixed fence. The top surface of the movable fence may be non-parallel with the top surface of the elongated tongue and the locking element may have a longitudinal axis that is angled relative to the front face of the fixed fence.

In one embodiment of the present invention, the movable fence may include a front support leg extending between the front face of the movable fence and the elongated groove, and a rear support leg extending between the rear face of the movable fence and the elongated groove. The front and rear support legs are preferably spaced from one another. The front support leg desirably engages the top surface of the fixed fence and the leading face of the elongated tongue, and the rear support leg desirably engages the top surface of the fixed fence. The engagement of the support legs with these surfaces stabilizes the movable fence relative to the fixed fence. The at least one spring desirably engages the rear support leg for urging the front support leg into engagement with the leading face of the elongated tongue.

In one embodiment of the present invention, the elongated tongue has a width W₁ extending from the leading face to the trailing face of said elongated tongue, and the elongated groove has a width W₂ extending from the front support leg to the rear support leg. The width W₁ of the elongated tongue preferably matches the width W₂ of the elongated groove. In one embodiment of the present invention, the groove may have a bottom surface that is inclined between the front and rear support legs. The incline of the bottom surface of the groove may match the incline of the top surface of the tongue.

In one embodiment of the present invention, a miter saw includes a base, a table rotatably coupled with the base, the table having a substantially planar top surface, and a cutting assembly connected to the table. The cutting assembly preferably includes a cutting blade, a motor for driving the cutting blade, and a linkage for selectively moving the cutting assembly relative to the top surface of the table. The miter saw also desirably includes a fence assembly attached to the base and overlying the top surface of the table. The fence assembly preferably has a fixed fence having a front face, a rear face, a top surface extending between the front and rear faces, and an elongated tongue projecting from the top surface. The fence assembly also preferably includes a movable fence having a front face, a rear face and an elongated groove formed in an underside thereof adapted to engage the elongated tongue for guiding movement of the movable fence over the fixed fence. The fence assembly desirably has at least one spring projecting from the elongated tongue and contacting the movable fence for urging the movable fence toward the rear face of the fixed fence and into engagement with the fixed fence.

The elongated tongue may include at least one pocket formed therein that faces toward the rear face of the fixed fence, and the at least one spring is desirably disposed in the at least one pocket. The at least one spring may include two or more springs projecting from a trailing face of the elongated tongue, the two or more springs being spaced from one another.

In one embodiment, the fixed fence has a bore accessible at a top surface of the elongated tongue, and the movable fence has a top surface with an elongated slot extending from the top surface thereof to the elongated groove located at an underside of the movable fence. The fence assembly may also include a fastener or locking element, such as a locking screw, extendable through the elongated slot of the movable fence and into the bore of the fixed fence for selectively fixing the position of the movable fence relative to the fixed fence. The locking element may have a first position for enabling movement of the movable fence relative to the fixed fence, and a second position for preventing movement of the movable fence relative to the fixed fence. The locking element may include a threaded shaft, and the bore accessible at the top surface of the elongated tongue may be internally threaded. In one embodiment, the threaded shaft has a central axis that is angled relative to the front face of the movable fence. The longitudinal axis of the threaded shaft preferably forms an angle with the front face of the movable fence of between about 0-20 degrees and more preferably about 5 degrees. As will be described in more detail herein, providing an inclined shaft provides more hand clearance for loosening and tightening the locking element. In one embodiment, the top surface of the movable fence is inclined relative to the top surface of the table. In another embodiment, however, the top surface of the movable fence is substantially parallel with the top surface of the table.

In one embodiment of the present invention, a miter saw includes a base, a table rotatably coupled with the base, and a cutting assembly connected to the table. The cutting assembly desirably includes a cutting blade, a motor for driving the cutting blade, and a linkage for selectively moving the cutting assembly relative to the table. The miter saw preferably includes a fence assembly attached to the base and overlying a top surface of the table.

The fence assembly desirably includes a fixed fence having a front face, a rear face, a top surface extending between the front and rear faces, and an elongated tongue projecting from the top surface of the fixed fence. The elongated tongue may include a leading face facing the front face of the fixed fence, a trailing face facing said rear face of the fixed fence, and a top surface extending between the leading and trailing faces of the tongue. The movable fence desirably includes a front face, a rear face, an elongated groove formed in an underside thereof, a front support leg extending between the front face of the movable fence and the elongated groove, and a rear support leg extending between the rear face of the movable fence and the elongated groove. The front and rear support legs are desirably spaced from one another.

The elongated tongue of the fixed fence is preferably engageable with the elongated groove of the movable fence for guiding movement of the movable fence over the fixed fence. The front support leg desirably engages the top surface of the fixed fence and the leading face of the tongue. The rear support leg desirably engages the top surface of the fixed fence adjacent the trailing face of the tongue. The spaced support legs preferably enhance stabilization between the movable fence and the fixed fence. In one embodiment, the front and rear support legs of the movable fence may be spaced from one another about 1.0-2.0 inches, more preferably about 1.3-1.4 inches, and even more preferably about 1.34 inches. In one embodiment, the ratio of the height of the front face of the movable fence to the spacing between the front and rear support legs of the movable fence is in the range of about 2.0-2.5:1.0-1.5 and more preferably about 2:1.3.

The fence assembly may include at least one spring projecting from the trailing face of the elongated tongue for engaging the rear support leg of the movable fence for urging the front support leg of the movable fence against the leading face of the tongue. In one embodiment of the present invention, the elongated tongue has at least one pocket formed therein that faces toward the rear face of the fixed fence, and the at least one spring is disposed in the at least one pocket. The at least one spring may include at least two springs projecting from the trailing face of the elongated tongue, whereby the springs are preferably spaced from one another.

In one embodiment of the present invention, the fixed fence desirably includes an internally threaded bore accessible at the top surface of the tongue, and the movable fence preferably has an elongated slot extending from a top surface thereof to the elongated groove formed in the underside of the movable fence. The fence assembly may include a fastener such as a locking screw insertable through the elongated slot and into the internally threaded bore for selectively affixing the position of the movable fence relative to the fixed fence.

These and other preferred embodiments of the present invention will be described in more detail below.

### BRIEF DESCRIPTION OF THE DRAWINGS

So the manner in which the above recited features of the present invention can be understood in detail, a more particular description of embodiments of the present invention, briefly summarized above, may be had by reference to embodiments, which are illustrated in the appended drawings. It is to be noted, however, the appended drawings illustrate only typical embodiments encompassed within the scope of the present invention, and, therefore, is not to be considered limiting, for the present invention may admit to other equally effective embodiments, wherein:

FIG. 1 shows a perspective view of a miter saw having an adjustable fence, in accordance with one embodiment of the present invention.

FIG. 2 shows a front view of the miter saw of FIG. 1.

FIG. 3 shows a rear view of the miter saw of FIGS. 1 and 2.

FIG. 4 shows a side view of the miter saw of FIGS. 1-3.

FIG. 5 is a top plan view of the miter saw of FIG. 1, showing the position of a cutting blade relative to an adjustable fence in a straight cross-cutting position and a miter cutting position.

FIG. 6 is a front elevation view of the adjustable fence of FIG. 5, showing the position of the cutting blade relative to the adjustable fence in a straight cutting position and a bevel cutting position.

FIG. 7A shows an exploded end view of a fence for a miter saw, in accordance with one embodiment of the present invention.

FIG. 7B shows an end view of the fence of FIG. 7A, after a movable fence has been assembled with a fixed fence.

FIG. 8 shows a rear perspective view of the fence shown in FIG. 7B.

FIG. 9A shows a cross-sectional view of the fence shown in FIG. 7A.

FIG. 9B shows a cross-sectional view of the fence shown in FIG. 7B.

FIG. 10 shows a rear perspective view of the fixed fence part of the fence shown in FIGS. 9A and 9B.

FIG. 11 shows another cross-sectional view of the fence shown in FIG. 7B.

FIG. 12 shows a top plan view of a fence for a miter saw including a fixed fence and a movable fence, in accordance with one embodiment of the present invention.

FIG. 13 shows a rear perspective view of the fence shown in FIG. 12 after the movable fence has been assembled with the fixed fence.

FIG. 14 shows an end view of the fence shown in FIG. 13.

### DETAILED DESCRIPTION

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. For purposes of clarity, and in order to described one or more embodiments of the present invention, terms such as “vertical,” “horizontal,” “perpendicular,” “parallel,” “front,” “rear,” “trailing,” “leading,” “first end,” and “second end” have been used herein. Such terms are merely used to provide a frame of reference for the embodiments shown in the drawings and are not intended to limit the scope of the present invention.

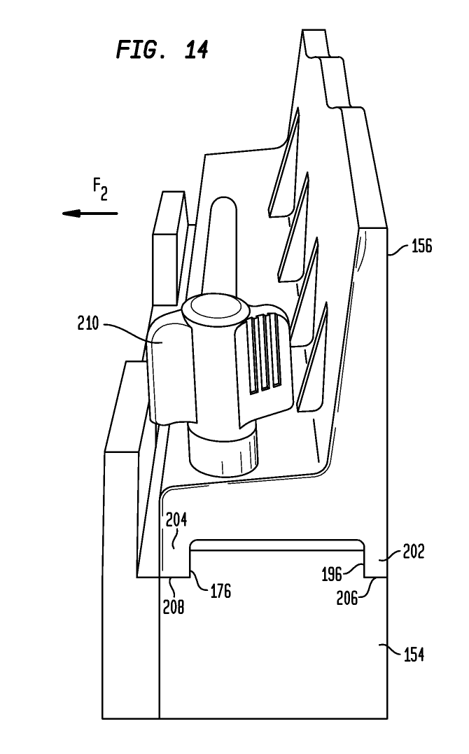

Referring to FIG. 14, in one preferred embodiment of the present invention, a sliding compound miter saw 20 includes a base 22, a table 24, a compound pivot and slide mounting linkage 26, a cutting blade 28, a blade guard 30, a motor 32 drivingly connected to the cutting blade 28, a handle 34, and an adjustable fence assembly 36 including a first fence section 38 and a second fence section 40. The table 24 is rotatably coupled with the base 22 so that it can be selectively rotated in order to provide a plurality of different angles for miter cutting. The rotation of the table 24 changes the angle of cutting blade 28 relative to the adjustable fence assembly 36, but maintains the cutting blade 28 perpendicular to the horizontally-extending top surface of the table 24. A locking mechanism 42 is movable between an unlocked position and a locked position for selectively unlocking and locking the table 24 for movement relative to the base 22.

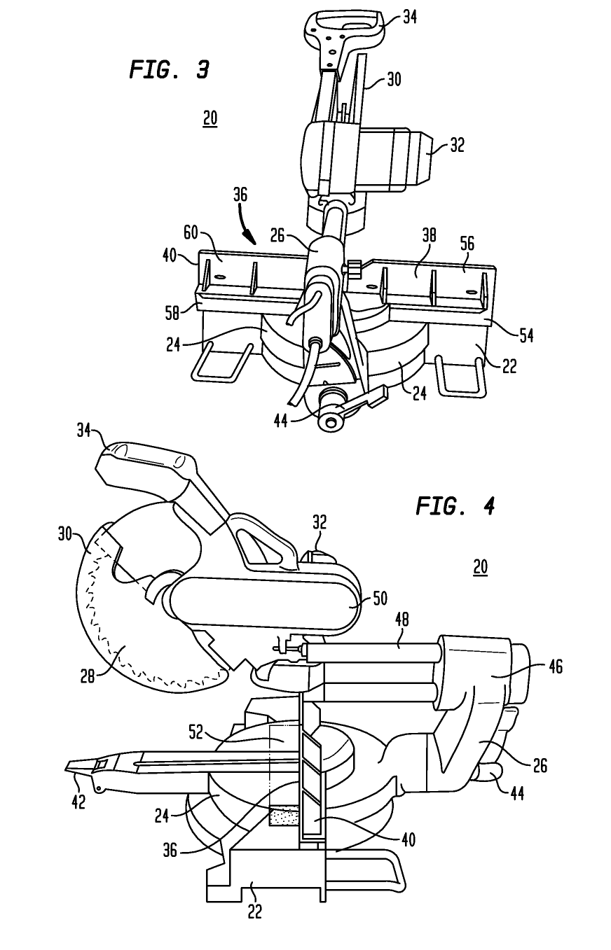

The compound pivot and slide mounting linkage 26 preferably couples the cutting blade 28 with the table 24. The compound pivot and slide mounting linkage 26 includes a pivoting structure that enables the cutting blade 28 to be pivoted with respect to the table 24 in order to provide adjustments for bevel cutting. As is well-known by those skilled in the art, the adjustments for mitering and beveling can be separate or they can be adjusted simultaneously in order to provide compound miter and bevel cuts. The pivoting of the compound pivot and slide mounting linkage 26 changes the angle of the cutting blade 28 relative to the table 24, but maintains the perpendicularity of the cutting blade 28 with respect to the adjustable fence assembly 36. Referring to FIGS. 3 and 4, a locking mechanism 44 can be activated in order to lock the compound pivot and slide mounting linkage 26 from further movement relative to the table 24. Thus, the cutting blade 28 may be locked at a plurality of different bevel angles, and the angle will not change so long as the locking mechanism 44 remains locked.

Referring to FIGS. 1 and 4, the compound pivot and slide mounting linkage 26 includes a support housing 46 provided at an upper end thereof that is adapted to receive a pair of support arms 48 for enabling forward and rearward sliding movement of a drive housing 50 relative to the compound pivot and slide mounting linkage 26. The cutting blade 28, blade guard 30, motor 32 and handle 34 are all mounted to the drive housing 50, which, in turn, is pivotably secured to the support arms 48. Referring to FIG. 4, the drive housing 50 may be pivoted downwardly toward the horizontally-extending top surface of the table 24. This downward pivoting action opens the blade guard 30 to expose the cutting blade 28. After the cutting blade has been exposed, it may be used to cut workpieces 52 supported by the table 24 and the fence 36. The sliding movement of the support arms 48 relative to the compound pivot and slide mounting linkage 26 permits the drive housing 50 and thus the cutting blade 28 to be pulled through the workpiece 52 in instances where the size of the workpiece exceeds the cutting width of the cutting blade.

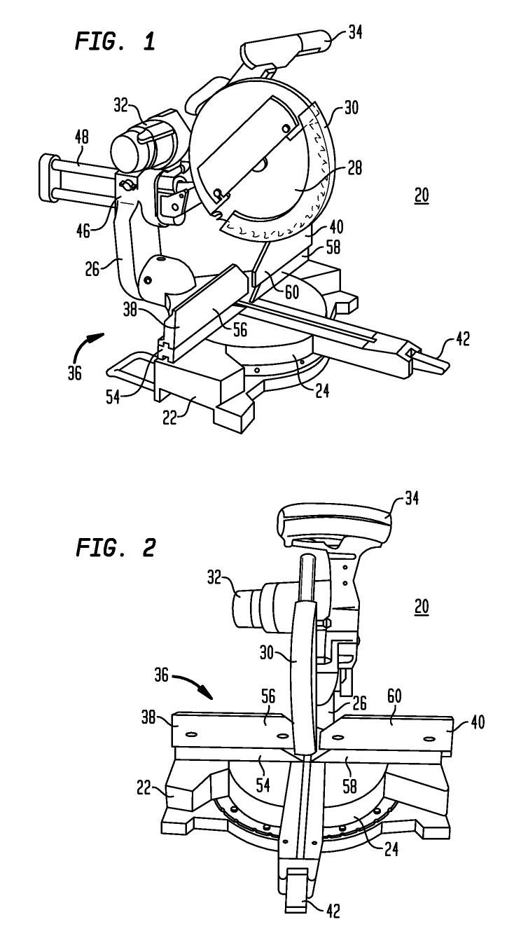

Referring to FIGS. 1-3, in one embodiment of the present invention, the adjustable fence 36 is interconnected with the base 22 and extends laterally across the horizontally-extending top surface of the rotatable table 24. The adjustable fence 36 is adapted to support and properly align a workpiece 52 during a cutting operation. The adjustable fence 36 includes a first fence part 38 having a fixed fence 54 and a movable fence 56 that is slidable over the fixed fence 54. The adjustable fence 36 also includes a second fence part 40 having a fixed fence 58 and a moveable fence section that is slidable over the fixed fence 58. The first and second fence parts 38, 40 have vertically-extending support surfaces that extend in a mutually aligned lateral direction, with each movable fence 56, 60 being laterally spaced from the other. The lateral spacing between the two movable fences 56, 60 provides clearance for the cutting blade 28 to perform a cutting operation completely through the workpiece 52, regardless of the mode or type of cutting operation being performed. The movable fences 56, 60 are each movable toward and away from the cutting blade 28 in order to allow the operator to selectively adjust the clearance gap therebetween and thus accommodate the particular cutting operation being performed.

One skilled in the art will readily recognize from the following description, taken in conjunction with the accompanying drawings and claims, that the principles of the present invention are equally applicable to sliding compound miter saws, compound miter saws, chop saws, radial arm saws, table saws, jigsaws, scroll saws, or other types of saws than those shown and described herein. Similarly, one skilled in the art will readily recognize that the principles of the adjustable workpiece-supporting fence according to the present invention are also applicable to other types of powered or unpowered equipment for performing an operation on a workpiece. Such equipment includes, but is not limited to, dado saws, spindle shapers or sanders, or other types of powered or unpowered devices that would benefit from the adjustable workpiece-supporting fence of the present invention.

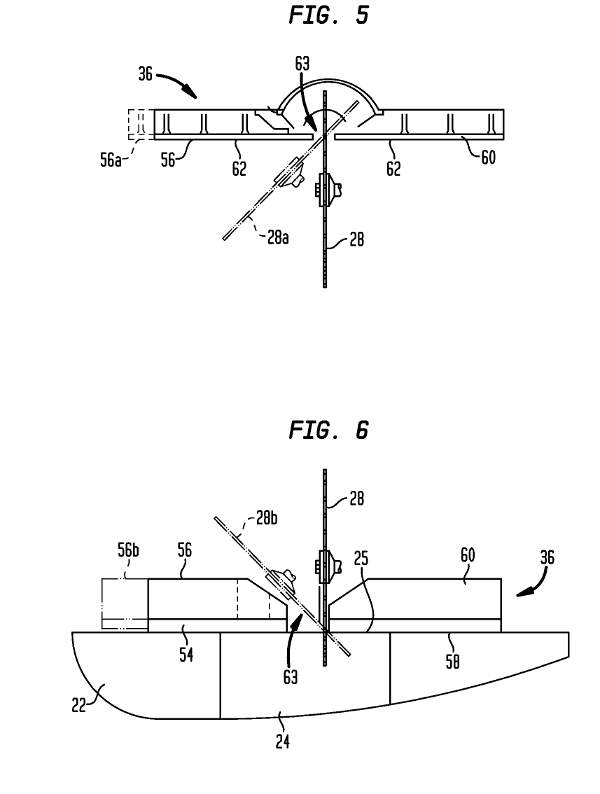

Referring to FIGS. 5 and 6, in certain preferred embodiments of the present invention, the miter saw 20 is capable of a number of different cutting modes or positions. Referring to FIG. 5, the cutting blade 28 (shown in solid lines) may be positioned at an angle that is perpendicular to the support face of the adjustable fence 36 for performing a straight sliding or straight miter-cutting operation. The movable fences 56, 60 are selectively adjusted to provide an optimum clearance gap between the cutting blade 28 and the two movable fences 56, 60, to permit the cutting blade 28 to be moved into the cutting position along a single, vertical plane, substantially perpendicular to both the front workpiece-supporting face 62 of the adjustable fence 36 and the top surface of the table 24 (FIG. 1). To permit miter cutting, as schematically illustrated in phantom lines in FIG. 5, the first movable fence 56 is selectively adjusted, as indicated in phantom by reference numeral 56a, to increase the clearance gap 63 between the cutting blade 28a and the first movable fence 56a. The wider gap 63 preferably provides sufficient clearance for the cutting blade 28a and any components associated therewith.

FIG. 6 shows a front elevational view of FIG. 5, depicting the position of the cutting blade 28 and the movable fences 56, 60 as solid lines for performing the above-described straight, square, and sliding cutting operation. The relative positions of the cutting blade 28 and the movable fence 56 are shown in phantom lines, as indicated by reference numerals 28b and 56b, respectively, for performing bevel cuts on a workpiece (not shown). The plane of movement of the cutting blade 28b is generally perpendicular to the face of fence assembly 36, but can be selectively oriented at a bevel angle with respect to the top surface 25 of the table assembly 24. As described above, the first movable fence 56 can be adjusted to a predetermined position, as shown in phantom at 56b, to accommodate the bevel angle selected for the cutting blade 28b. In one embodiment of the present invention, fence section 56 is slidable laterally over fixed fence 54, and fence section 60 is slidable laterally over fixed fence 58. The two movable fences 56, 60 are capable of moving independently of one another for adjusting the size of the gap 63 therebetween.

Although not specifically illustrated in the drawings, one skilled in the art will readily recognize, from the exemplary positions shown in FIGS. 5 and 6, that a miter-cutting operation can be combined with a bevel-cutting operation in order to perform compound mitering. In a compound mitered cut, the cutting blade 28 moves in a plane that is not perpendicular to either the front, vertically-extending face 60 of the adjustable fence 36 or to the top, horizontally-extending face 25 of the table 24. In addition, although not specifically illustrated in the drawings, one skilled in the art will readily recognize, from the exemplary positions diagrammatically illustrated in FIGS. 5 and 6, that the miter-cutting operation and the bevel-cutting operation can be performed by angling the cutting blade 28 in the opposite direction from what is illustrated and then selectively adjusting movable fence 60 (to the right in FIGS. 5 and 6) in a manner similar to that shown for movable fence 56.

Thus, the sliding compound miter saw 20 shown and described herein is capable of making at least four general types of cutting operations, namely sliding, miter-cutting, bevel-cutting and compound miter-cutting operations. The miter-cutting, bevel-cutting and compound miter-cutting operations can be performed by angling the cutting blade 28 in either direction from the sliding operation due to the incorporation of movable fences 56, 60 on opposite sides of the cutting blade 28. The miter saw preferably has infinite compound adjustability of the relative position and orientation of the cutting blade 28 relative to both the table 24 and the adjustable fence 36. The infinite adjustability can be accomplished in the present invention by way of the compound pivot and slide mounting linkage 26 shown and described above in FIG. 14. The compound pivot and slide mounting mechanism 26 can be any of a number of well-known pivot and bevel mounting and support mechanisms which also allow cutting blade 28 and cutting blade guard 30 to be pivotally and slidably moved from a rear, raised, dear position to a lowered or cutting position, once miter saw 20 is adjusted to the desired operating mode, in order to perform a cutting operation on a workpiece by lowering the cutting blade 28 into the workpiece and then moving the cutting blade 28 longitudinally through the workpiece. In order to allow a complete cut-through operation to be performed on the workpiece by the cutting blade 28, the fence assembly 36 must be capable of selective adjustment in order to adjust the lateral clearance gap or spacing between the cutting blade 28 and the two movable fences 56, 60, while still providing adequate vertical support for the workpiece.

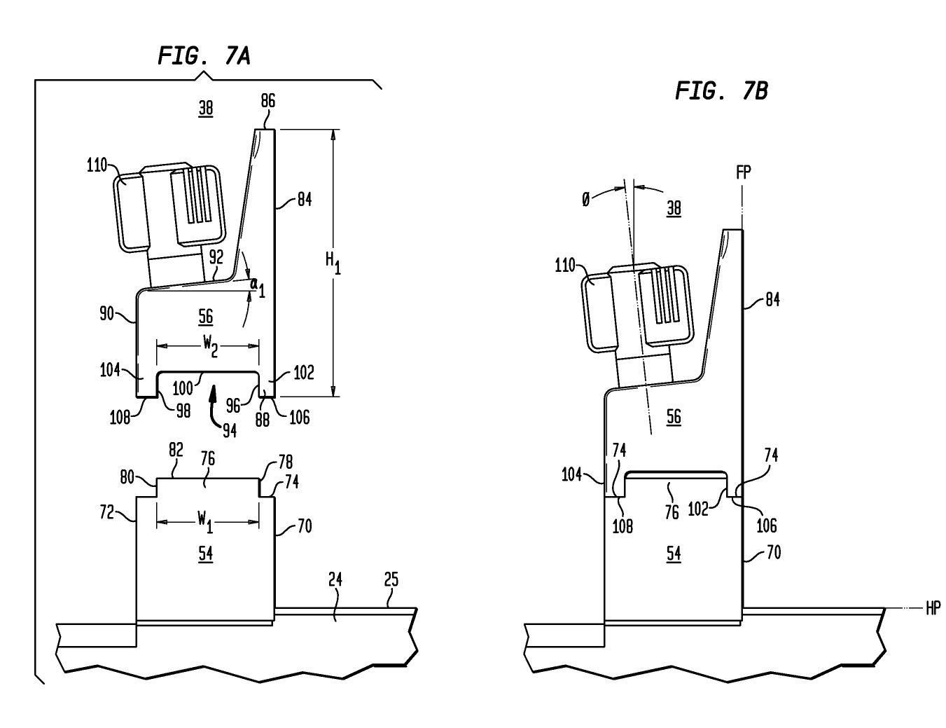

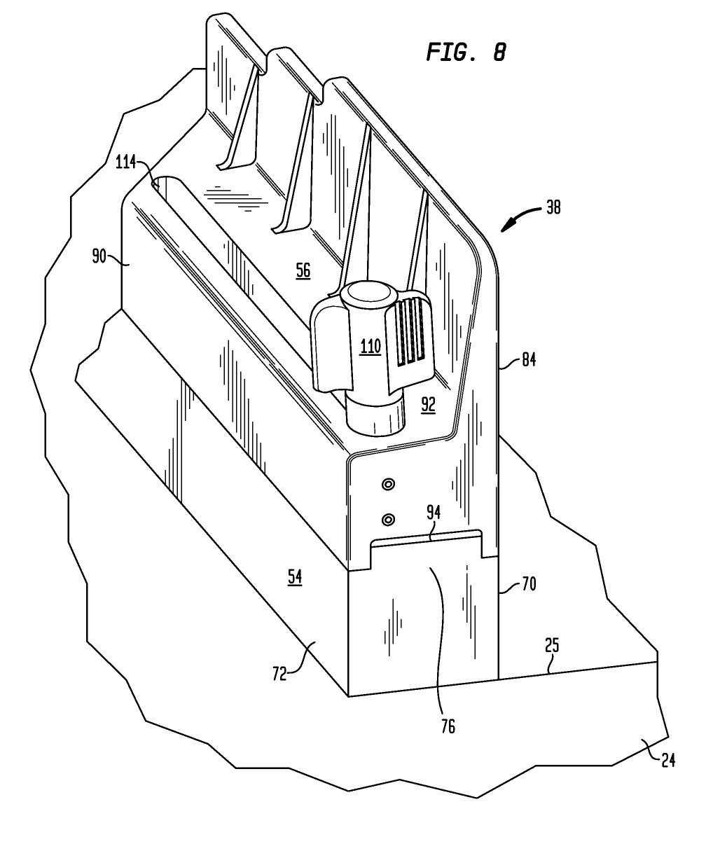

FIG. 7A shows an adjustable fence 38 including a fixed fence 54 and a movable fence 56 that is adapted to be coupled with the fixed fence 54. In one embodiment, the movable fence 56 may be slid over the top of the fixed fence for adjusting the size of a gap between two adjacent fence parts. The fixed fence 54 is preferably attached to a substrate, such as the base of a miter saw. The fixed fence 54 desirably overlies the top, horizontally-extending surface 25 of a table 24. The fixed fence 54 may be a separate component that is attached to the base, or may be integrally formed with the base. For example, the fixed fence may be a projection that extends from a top of the base or the top of the table 24. The fixed fence 54 includes a front, workpiece supporting face 70 that is substantially perpendicular to the top surface 25 of the table 24. The fixed fence 54 also includes a rear face 72, and a first top surface 74 that extends between the front and rear faces 70, 72. The fixed fence 54 also desirably includes a tongue 76 that projects upwardly from the first top surface 74 of the fixed fence 54. The tongue 76 preferably extends along the length of the fixed fence between the front and rear faces 70, 72, and between a first end and a second end of the fixed fence. The tongue 76 desirably has a leading face 78 that faces toward front face 70, a trailing face 80 that faces toward rear face 72, and a top surface 82 that extends between the front and rear faces 78, 80 thereof. In one embodiment, the front workpiece supporting face 70 extends in a plane that is substantially perpendicular to the top surface 25 of the table assembly 24, the first top surface 74 of the fixed base, and the top surface 82 of the tongue 76. The leading and trailing faces 78, 80 of the tongue 76 are desirably parallel to one another, parallel to the front face 70, and substantially perpendicular to the top surface 74 of the fixed fence 54 and the top surface 82 of the tongue 76.

In one embodiment of the invention, the top surface 82 of the tongue 76 may be discontinuous. In one embodiment, the top surface 82 may be parallel with the top surface of the tongue, or may be inclined or non-parallel relative to the top surface of the tongue. For example, the leading face 78 of the tongue 76 may have a different height than the trailing face 80 of the tongue 76 so that the top surface 82 is inclined between the leading and trailing faces 78, 80. An opposing groove on the movable fence may have an inclined surface that matches the inclined top surface of the tongue.

The fence assembly 38 desirably includes the movable fence 56 that may be coupled with the fixed fence 54. The movable fence 56 includes a front workpiece supporting face 84 that extends from an upper end 86 to a lower end 88 thereof. When the movable fence and the fixed fence are coupled together, the front face 70 of the fixed fence and the front face 84 of the movable fence preferably lie in a common plane. The two front supporting faces 70, 84 preferably cooperate together to provide a continuous, uniform support surface for a workpiece. The support surface preferably extends in a substantially vertical direction. The movable fence 56 desirably includes a rear face 90, and a top face 92 that extends between the front face 84 and the rear face 90. As shown in FIG. 7A, the top face 92 of the movable fence is desirably inclined relative to a horizontal plane. The angle of incline is preferably about 0-20, more preferably about 0-15 degrees, and even more preferably about 3-7 degrees. In one embodiment, the top face 92 is not inclined, and extends substantially horizontally, or in a direction that is substantially parallel with the top surface 25 of the table 24.

An underside of the movable fence 56 desirably has an elongated groove 94 formed therein that extends between the front and rear faces 84, 90, and along the length of the movable fence, between a first end and a second end thereof. The elongated groove 94 desirably has a leading inner face 96, a trailing inner face 98, and a bottom surface 100 that extends between the leading inner face 96 and the trailing inner face 98. In one embodiment, the front face 84, the leading inner face 96, and the trailing inner face 98 are parallel to one another and substantially perpendicular to the bottom surface 100. The top surface 92 of the movable fence 56 is desirably non-parallel with the bottom surface 100. The top surface 92 may be inclined at an angle α1 of about 0-15 degrees. In one embodiment, the top surface 92 is inclined at an angle of about 5 degrees.

Referring to FIG. 7A, the movable fence 56 also preferably includes a front support leg 102 extending between the front face 84 and the leading inner face 96, and a rear support leg 104 extending between the rear face 90 and the trailing inner face 98. The front and rear support legs 102, 104 are preferably spaced from one another, and preferably extend laterally between the first and second ends of the movable fence 56. The front support leg 102 has a bottom surface 106 that extends between the leading face 84 and the leading inner face 96, and the rear support leg 104 has a bottom surface 108 that extends between the rear face 90 and the trailing inner face 98. The bottom surfaces 106, 108 of the respective legs 102, 104 are adapted to oppose the top surface 74 of the fixed base 54 when the movable fence 56 is assembled with the fixed base. The bottom surface 106 of the front support leg 102 desirably contacts a portion of the top surface 74 in front of the tongue 76, and the bottom surface 108 of the rear support leg 104 desirably contacts a portion of the top surface 74 that is located rearwardly of the tongue 76.

In one embodiment, the front and rear support legs 102, 104 may have different heights, whereby the bottom surface 100 of the groove 94 is inclined between the front and rear support legs 102, 104. In one embodiment, the bottom surface 100 of the groove 94 and the top surface 82 of the tongue 76 may be inclined. The inclines of the bottom surface 94 and the top surface 82 may match one another.

Referring to FIGS. 7A and 7B, the top surface 82 of the tongue 76 preferably has a width W₁ that generally matches the width W₂ of the groove 94. The respective widths W₁, W₂ preferably remain constant in dimension between the ends of the fixed fence 54 and the movable fence 56. As a result, when the movable fence 56 is assembled with the fixed base 54, the tongue 76 forms a precise fit with the groove 94 to provide stability between the two parts. In one embodiment, the term “precise fit” means that the dimensions of the tongue and the groove are closely matched, however, the movable fence remains capable of sliding over the fixed fence. In one embodiment, when the movable fence 56 and the fixed fence 54 are coupled together, the leading face 78 of the tongue 76 engages the leading inner face 96 of the groove 94, and the trailing face 80 of the tongue 76 engages the trailing inner face 98 of the groove 94. The engagement of the opposing surfaces extends between the ends of the fence parts. The large surface area of the opposing surfaces enhances the level of stability between the movable fence 56 and the fixed fence 54.

In one embodiment of the present invention, the distance between the leading inner face 96 and the trailing inner face 98 of the respective front and rear support legs 102, 104 is about 1.0-2.0 inches, more preferably about 1.30-1.40 inches, and even more preferably about 1.34 inches. This distance is designated in FIG. 7A by the reference W₂. The above-noted description between the support legs provides stability for the movable fence relative to the fixed fence. The level of stability may be indicated by the ratio of the height H₁ of the front face 84 of the movable fence to the width W₂ of the groove 94. In one embodiment, the ratio of the height H₁ to the width W₂ is about 2:1.3. In other preferred embodiments, the ratio H₁ to W₂ may be anywhere is a range of about 2.0:1.0 to about 2.3:1.3. As is well known to those skilled in the art, the stability of the movable fence atop the fixed fence will generally be improved as the distance between the front and rear support legs 102, 104 increases.

The adjustable fence 38 also preferably includes a locking screw 110 that is used for securing the movable fence 56 to the fixed fence 54. The locking screw 110 preferably extends through an elongated groove (not shown) formed in the movable fence 56. The top surface 82 of the tongue 76 desirably has a threaded bore formed therein that is adapted to receive a threaded portion of the locking screw 110. The locking screw 110 may be loosened for moving the movable fence 56 relative to the fixed fence 54, and tightened for fixing the position of the movable fence 56 relative to the fixed fence 54.

FIG. 7B shows the adjustable fence 38 after the movable fence 56 has been coupled with the fixed fence 54. After assembly, the bottom surface 106 of the front support leg 102 engages the top surface 74 of the fixed base 54 on the front or leading side of the tongue 76, and the bottom surface 108 of the rear support leg 104 engages the top surface 74 of the fixed base 54 on the rear or trailing side of the tongue 76. The space between the front and rear support legs 102, 104 preferably closely matches the width W₁ of the tongue 76 so as to form a precise fit between the tongue 76 of the fixed fence 54 and the groove 94 of the movable fence 56. After the movable fence 56 and the fixed fence 54 have been coupled together, the front face 84 of the movable fence 56 and the front face 70 of the fixed fence 54 preferably lie in a common plane.

Although the present invention is not limited by any particular theory of operation, it is believed that the relatively wide spacing of the support legs 102, 104 on opposite sides of the tongue 76 provide enhanced stability to the adjustable fence 38 that cannot be obtained with conventional fence structures. It is theorized that this may be because the support legs 102, 104 are sufficiently spaced from one another, and because the support legs extend substantially along the entire length of the adjustable fence, between first and second ends thereof. In one embodiment, the spacing between the front and rear support legs 102, 104 is about 1.0-2.0 inches and more preferably about 1.3 inches. Stability between the movable fence and the fixed fence may also be because there is an increased surface area of contact between the movable fence 56 and the fixed fence 54. Moreover, the space between the support legs 102, 104 closely matches the width W₁ of the tongue 76, which further enhances the stability between the movable fence and the fixed fence. Such enhanced stability insures that the front workpiece supporting face 70 of the fixed fence 54 and the front workpiece supporting face 84 of the movable fence 56 lie in a uniform, common plane, and that the leading faces 70, 84 do not shift or move relative to one another after the locking screw 110 has been tightened.

Referring to FIG. 8, as the fixed fence 54 is assembled with the movable fence 56, the tongue 76 is disposed within the groove 94 formed in the underside of the movable fence. The movable fence is preferably slidable along the tongue 76 for adjusting the position of the movable fence relative to the fixed fence 54. When the movable fence is in the desired position, the locking screw 110, which extends through the elongated slot 114, may be tightened. The top surface 92 of the movable fence 56 is inclined to provide clearance for the head of the locking screw 110. In other embodiments, any type of fastener may be used instead of a locking screw such as a locking nut or a cam-operated fastener.

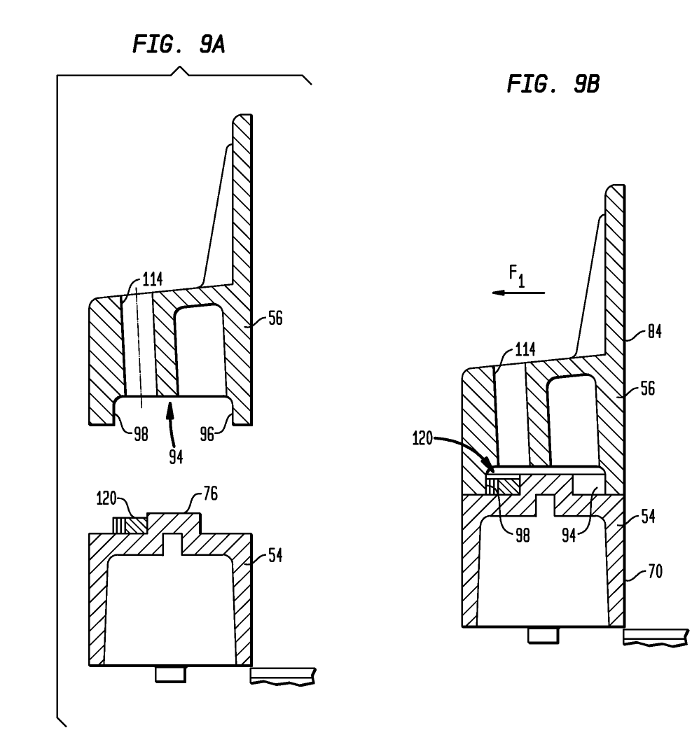

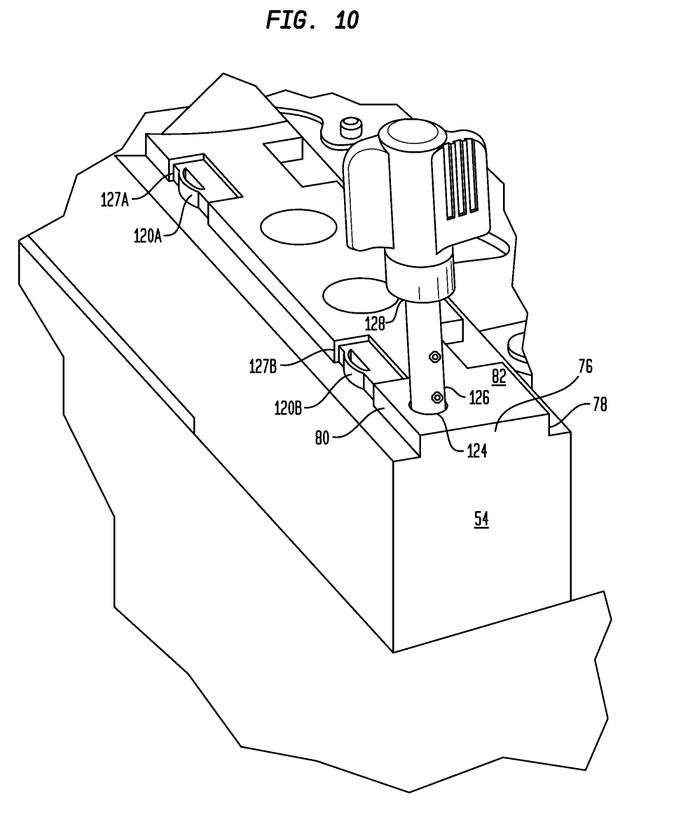

Referring to FIGS. 9A-9B and 10, in one embodiment of the present invention, the fixed base 54 has springs 120A, 120B that project from the trailing face 80 of the tongue 76. In one embodiment, the springs 120A, 120B are disposed within pockets 127A, 127B formed in the trailing face 80 of the tongue 76. Referring to FIGS. 9A and 9B, when the elongated groove 94 of the movable fence 56 is positioned over the elongated tongue 76, the springs 120 preferably exert a spring force on the trailing inner face 98 of the movable fence 56. The spring force, designated Fi, preferably urges the movable fence 56 in the direction shown in FIG. 9B, which, in turn, urges leading inner surface 96 against the leading face 78 of the tongue 76 for stabilizing the movable fence relative to the fixed fence. Thus, the springs 120A, 120B further enhance alignment and stability of the front workpiece supporting faces 70 and 84 relative to one another. Moreover, when a workpiece is pressed against the front faces 70, 84, the force exerted through the workpiece does not counter the force of the springs 120A, 120B, but rather works with the springs to insure stability of the fence parts relative to one another. Moreover, when a user pushes a workpiece against the fence, the leading inner face 96 of the front support leg 102 engages substantially the entire length of the leading face 78 of the tongue 76, which enhances the stability of the movable and fixed fences relative to one another, and insures that the front face 84 of the movable fence and the front face 70 of the fixed fence remain coplanar.

In the embodiment shown in FIG. 10, the adjustable fence includes a pair of springs that project from a trailing side of the tongue. In other embodiments, however, the fixed fence may have a single spring projecting from the tongue, or three or more springs projecting from the tongue. The springs may also project from the leading face of the tongue, or from both the leading and trailing faces of the tongue. In one highly preferred embodiment, however, the springs project from the trailing side of the tongue for enhancing alignment of the front vertical faces 70, 84, and for improving stability between the movable fence and the fixed fence.

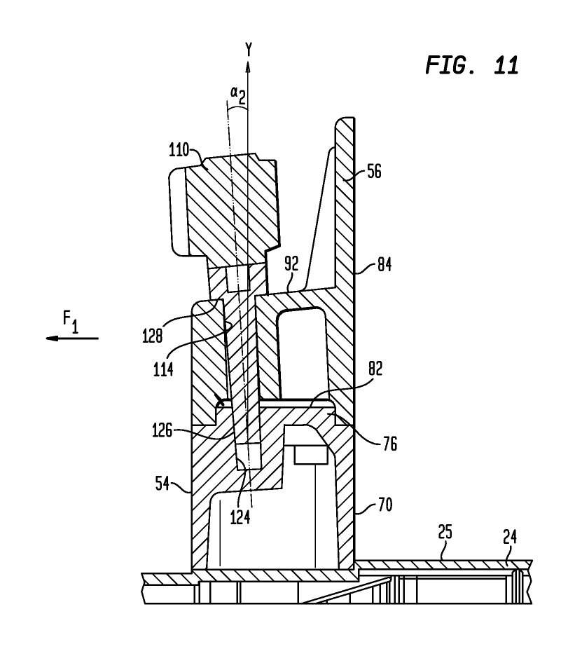

Referring to FIGS. 10 and 11, in one embodiment of the present invention, the fixed fence 54 preferably includes an internally threaded bore 124 that is accessible at the top surface 82 of the tongue 76. After the fixed fence 54 and the movable fence 56 are coupled together, the elongated slot 114 of the movable fence is preferably in alignment with the internally threaded bore 124 of the fixed fence. The elongated slot 114 desirably remains in alignment with the bore as the position of the movable fence relative to the fixed fence is adjusted. In order to lock the fence parts together, a threaded shaft 126 of the locking screw 110 may be passed through the elongated slot and screwed into the internally threaded bore 126. Referring to FIG. 11, the locking screw 110 preferably includes a shoulder 128 located at an upper end of the threaded shaft 126. The shoulder desirably has an underside surface that engages the inclined top surface 92 of the movable fence 56 when the locking screw 110 is tightened.

In one embodiment of the present invention, after the movable fence 56 is positioned atop the tongue 76 of the fixed fence, the movable fence may be slid along the tongue until an optimal gap in the fence is obtained. The other fence part on the other side of the gap may be moved in a similar fashion. As the position of the movable fence is being adjusted, the springs 120A, 120B (FIGS. 9B and 10) continue to urge the movable fence 56 in the direction indicated by arrow F₁, which enhances the stability between the movable fence and the fixed fence, and which also insures proper alignment of the leading faces 70, 84 of the fixed fence and the movable fence. Referring to FIG. 9B, when a workpiece is pushed against the aligned leading faces 70, 84, the movable fence cannot move any further to the left because it has already been fully advanced to the rear, and the tongue 76 prevents the movable fence from shifting any further to the rear relative to the fixed fence. In certain preferred embodiments, this may be because the inner face of the front support leg is in contact with the leading face of the tongue and cannot move any further to the rear.

As shown in FIG. 11, the longitudinal axis of the locking screw is inclined at an angle α2 relative to the top surface 25 of the table 24. The inclined angle provides for a more uniformly distributed locking force between the movable fence and the fixed fence. The incline of the fastener enables the locking force to be applied near a center of the movable fence, while the portion of the fastener to be engaged for tightening is positioned closer to an edge of the movable fence. Moreover, in prior art devices, the locking fastener or locking screw generally provides a locking force that is substantially parallel to the top surface of the table, which has been shown to result in improper alignment between the front workpiece supporting faces of a movable fence and a fixed fence. The present invention avoids this problem by providing a downward locking force that has a substantially vertical orientation. Moreover, the incline of the locking screw 110 provides better clearance for grasping the head of the locking screw when tightening and untightening the locking screw. Although a locking screw is shown in FIG. 11, it is contemplated that any well-known locking device may be used, such as a bolt, a latch, a cam, etc.

In one embodiment of the present invention, the width of the tongue on the fixed fence is slightly smaller than the width of the groove on the movable fence. The fence includes at least one spring disposed between the tongue and the groove for urging opposing surfaces of the movable and fixed fences to contact one another so as to provide stability between the movable and fixed fences. The at least one spring may be attached to the movable fence or the fixed fence, or to both the movable fence and the fixed fence. In one embodiment, a first spring may be attached to the movable fence and a second spring may be attached to the fixed fence. In other embodiments, more than one spring may be attached to each fence part.

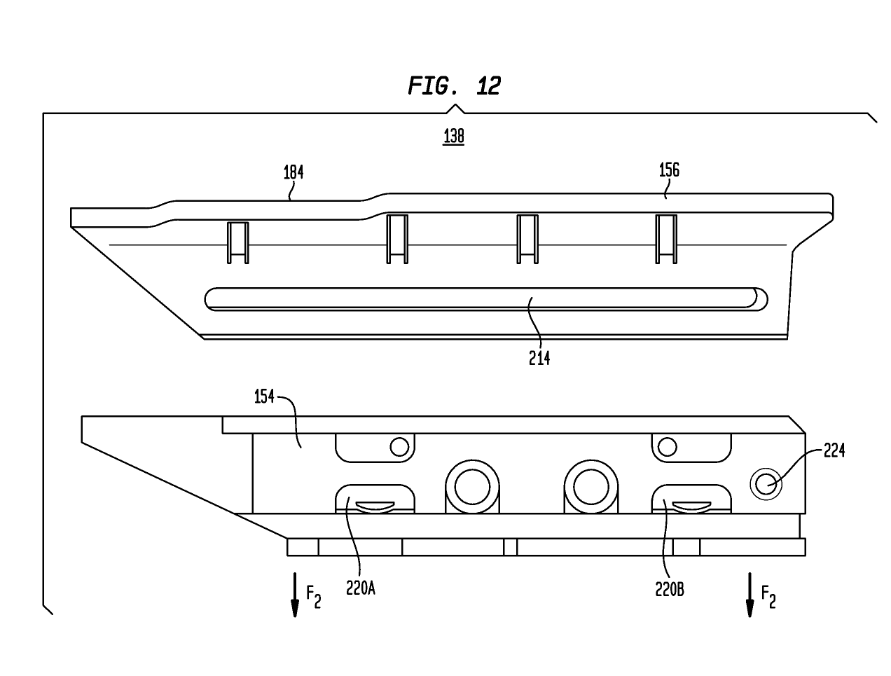

Referring to FIG. 12, in one embodiment of the present invention, an adjustable fence includes a fixed fence 154 that may be secured to a substrate such as the base of a miter saw or power equipment. The fixed fence desirably includes a pair of springs 220A, 220B that provide a spring force that normally urges an opposing surface to move in the direction indicated by arrow F₂. The fixed fence 154 has an internally threaded bore 224 that is accessible at a top surface of an elongated tongue. The adjustable fence 138 includes a movable fence 156 that is adapted to slide over the top of the fixed fence. The movable fence 156 includes an elongated slot 214 that extends along the length thereof, between first and second ends thereof. The elongated slot 214 preferably extends in a direction that is parallel with a front workpiece supporting face 184 of the movable fence 156.

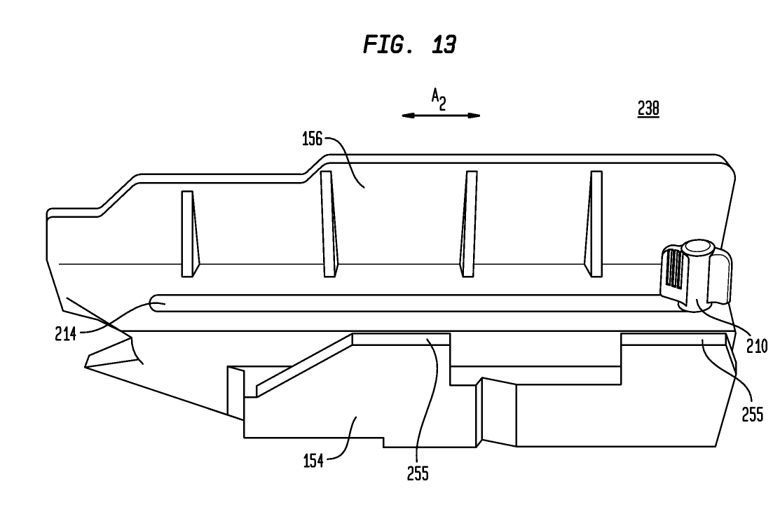

Referring to FIG. 13, the movable fence 156 may be coupled with the fixed fence 154 so that the elongated slot 214 is aligned with the internally threaded bore 224 (FIG. 12) provided on the fixed fence. After being coupled together, the movable fence 156 is free to slide over the fixed fence 154 along the axis designated A₂. When the movable fence 156 has been positioned in a desired location relative to the fixed fence 154 (to form an optimal clearance gap in the fence for a cutting blade), the locking screw 210 may be tightened to securing the parts from further movement relative to one another.

The adjustable fence 238 also has an auxiliary fence 255, such as the auxiliary fence disclosed in commonly assigned U.S. Patent Publication No. 2004/0103768, the disclosure of which is hereby incorporated by reference herein. The auxiliary fence desirably has a front workpiece supporting surface that is substantially vertical and/or that is parallel with the front workpiece supporting face of the adjustable fence. As described in U.S. 2004/0103768, the auxiliary fence 255 effectively increases the cutting capacity of the cutting equipment without requiring additional saw assembly travel and/or longer sliding rails. In one embodiment, the auxiliary fence may be a separate piece that is attachable to the fixed fence or to the base of the saw.

FIG. 14 shows an end view of the adjustable fence shown in FIGS. 12-13. The locking screw 210 is angled to provide hand clearance during loosening and tightening of the locking screw. The top surface of the movable fence 156 may also be inclined to facilitate the angling of the locking screw 210. The springs (not shown) provided on the trailing side of the tongue 176 apply a force on the trailing support leg 204 of the movable fence 156. The direction of the spring force is designated F₂. The spring force urges the inner face 196 of the leading support leg 202 against the leading face of the tongue 176. The bottom surfaces 206, 208 of the respective support legs 202, 204 provide a relatively broad support base that enhances perpendicularity of the front face of the fence, including coplanar front faces 70, 84, with a top surface of a table assembly. The broadly spaced support legs also enhance the stability between the movable fence 156 and the fixed fence 154.

One or more embodiments of the present invention may incorporate one or more features disclosed or suggested in commonly assigned U.S. Pat. Nos. 5,297,463; 6,426,309; 6,899,005; and 7,210,385; and U.S. Patent Application Publication Nos. 2002/0152867; 2004/0079214; 2004/0103768; and 2007/0214928, the disclosures of which are hereby incorporated by reference herein.

While the foregoing is directed to embodiments of the present invention, other and further embodiments of the invention may be devised without departing from the basic scope thereof.

What is claimed is:

1. A saw comprising:
a base;
a saw assembly coupled with said base, said saw assembly including a cutting blade, a motor for driving said cutting blade, and a linkage for selectively moving said saw assembly relative to said base; and
a fence assembly attached to said base, said fence assembly comprising
a fixed fence having a front face, and a rear face,
a movable fence having a front face and a rear face, and being movably connected to said fixed fence, and
at least one spring disposed between said fixed fence and said movable fence for urging said movable fence into engagement with said fixed fence.

2. The saw as claimed in claim 1, wherein said fixed fence further comprises a top surface extending between said front face and said rear face thereof, and an elongated tongue projecting from said top surface that extends between first and second ends of said fixed fence, and wherein said movable fence further comprises a top surface, a bottom surface, and an elongated groove formed in said bottom surface that extends between first and second ends of said movable fence, said elongated groove and said elongated tongue being engageable with one another for guiding movement of said movable fence relative to said fixed fence.

3. The saw as claimed in claim 2, wherein said elongated tongue comprises a leading face that is substantially parallel with said leading face of said fixed fence, a trailing face that is substantially parallel with said leading face of said elongated tongue, and a top surface extending between said leading and trailing faces, said top surface of said elongated tongue being substantially perpendicular to said front face of said fixed fence.

4. The saw as claimed in claim 3, wherein said at least one spring projects from said trailing face of said elongated tongue for engaging said movable fence.

5. The saw as claimed in claim 4, wherein said at least one spring urges said front face of said movable fence into substantial coplanar alignment with said front face of said fixed fence.

6. The saw as claimed in claim 4, wherein said at least one spring comprises two or more springs projecting from said trailing face of said elongated tongue, wherein said two or more springs are spaced from one another.

7. The saw as claimed in claim 2, wherein said elongated tongue of said fixed fence has a bore accessible at a top surface thereof, and said movable fence has an elongated slot extending from said top surface to said elongated groove thereof, said fence assembly further comprising a locking element extendable through said elongated slot of said movable fence and into said bore of said fixed fence for selectively locking said movable fence to said fixed fence.

8. The saw as claimed in claim 7, wherein said top surface of said movable fence is non-parallel with said top surface of said elongated tongue and said locking element has a longitudinal axis that is angled relative to said front face of said fixed fence.

9. The saw as claimed in claim 2, wherein said movable fence further comprises a front support leg extending between said front face of said movable fence and said elongated groove, and a rear support leg extending between said rear face of said movable fence and said elongated groove, said front and rear support legs being spaced from one another, and wherein said front support leg engages said top surface of said fixed fence and said leading face of said elongated tongue and said rear support leg engages said top surface of said fixed fence for stabilizing said movable fence relative to said fixed fence.

10. The saw as claimed in claim 9, wherein said at least one spring engages said rear support leg for urging said front support leg into engagement with said leading face of said elongated tongue.

11. The saw as claimed in claim 9, wherein said elongated tongue has a width W₁ extending from said leading face to said trailing face of said elongated tongue, and said elongated groove has a width W₂ extending from said front support leg to said rear support leg, and wherein said width W₁ substantially equals said width W₂.

12. A miter saw comprising:
a base;
a table rotatably coupled with said base, said table having a substantially planar top surface;
a cutting assembly connected to said table, said cutting assembly including a cutting blade, a motor for driving said cutting blade, and a linkage for selectively moving said cutting assembly relative to the top surface of said table; and
a fence assembly attached to said base and overlying the top surface of said table, said fence assembly comprising
a fixed fence having a front face, a rear face, a top surface extending between said front and rear faces, and an elongated tongue projecting from said top surface,
a movable fence having a front face, a rear face and an elongated groove formed in an underside thereof adapted to engage said elongated tongue for guiding movement of said movable fence over said fixed fence, and
at least one spring projecting from said elongated tongue and contacting said movable fence for urging said movable fence toward said rear face of said fixed fence and into engagement with said fixed fence.

13. The miter saw as claimed in claim 12, wherein said elongated tongue comprises at least one pocket formed therein that faces toward said rear face of said fixed fence, and said at least one spring is disposed in said at least one pocket.

14. The miter saw as claimed in claim 12, wherein said at least one spring comprises two or more springs projecting from a trailing face of said elongated tongue, said two or more springs being spaced from one another.

15. The miter saw as claimed in claim 12, wherein said fixed fence has a bore accessible at a top surface of said elongated tongue, and said movable fence has a top surface and an elongated slot extending from said top surface thereof to said elongated groove, said fence assembly further comprising a locking element extendable through said elongated slot of said movable fence and into said bore of said fixed fence for selectively fixing the position of said movable fence relative to said fixed fence.

16. The miter saw as claimed in claim 15, wherein said locking element has a first position for enabling movement of said movable fence relative to said fixed fence and second position for preventing movement of said movable fence relative to said fixed fence.

17. The miter saw as claimed in claim 16, wherein said locking element comprises a threaded shaft, and said bore accessible at said top surface of said elongated tongue is internally threaded.

18. The miter saw as claimed in claim 17, wherein said threaded shaft has a central axis that is angled relative to said front face of said movable fence.

19. The miter saw as claimed in claim 18, wherein said threaded shaft forms an angle of between about 2-10 degrees with said front face of said movable fence.

20. A miter saw comprising:
a base;
a table rotatably coupled with said base;
a cutting assembly connected to said table, said cutting assembly including a cutting blade, a motor for driving said cutting blade, and a linkage for selectively moving said cutting assembly relative to said table; and
a fence assembly attached to said base and overlying a top surface of said table, said fence assembly comprising
a fixed fence having a front face, a rear face, a top surface extending between said front and rear faces, and an elongated tongue projecting from said top surface of said fixed fence, said elongated tongue having a leading face facing said front face, a trailing face facing said rear face, and a top surface extending between said leading and trailing faces,
a movable fence having a front face, a rear face, an elongated groove formed in an underside thereof, a front support leg extending between said front face and said elongated groove, and a rear support leg extending between said rear face and said elongated groove, said front and rear support legs being spaced from one another,
said elongated tongue of said fixed fence being engageable with said elongated groove of said movable fence for guiding movement of said movable fence over said fixed fence, wherein said front support leg engages said top surface of said fixed fence and said leading face of said tongue and said rear support leg engages said top surface of said fixed fence adjacent said trailing face of said tongue for stabilizing said movable fence relative to said fixed fence.

21. The miter saw as claimed in claim 20, further comprising at least one spring projecting from said trailing face of said tongue and engaging said rear support leg for urging said front support leg of said movable fence against said leading face of said tongue.

22. The miter saw as claimed in claim 21, further said at least one spring comprises at least two springs projecting from said trailing face of said elongated tongue, said springs being spaced from one another.

23. The miter saw as claimed in claim 20, wherein said fixed fence includes an internally threaded bore accessible at said top surface of said tongue, and said movable element has an elongated slot extending from a top surface thereof to said elongated groove formed in said underside thereof, and wherein said fence assembly further comprises a locking screw insertable through said elongated slot and into said internally threaded bore for selectively affixing the position of said movable fence relative to said fixed fence.

24. The miter saw as claimed in claim 21, wherein said elongated tongue comprises at least one pocket formed therein that faces toward said rear face of said fixed fence, and said at least one spring is disposed in said at least one pocket.
